(19) United States
(12) Patent Application Publication
(10) Pub. No.: US 2023/0297611 A1
(43) Pub. Date: Sep. 21, 2023

(54) INFORMATION SEARCH DEVICE

(71) Applicant: HITACHI, LTD., Tokyo (JP)

(72) Inventors: Kentaroh SANO, Tokyo (JP); Atsushi MAKI, Tokyo (JP); Yuto KOMATSU, Tokyo (JP); Azusa AMINO, Tokyo (JP); Zhuonan YAO, Tokyo (JP); Sachi TANAKA, Tokyo (JP); Akiyoshi OOHIRA, Tokyo (JP)

(73) Assignee: HITACHI, LTD., Tokyo (JP)

(21) Appl. No.: 18/008,343

(22) PCT Filed: Apr. 21, 2021
(86) PCT No.: PCT/JP2021/016110

§ 371 Date: Dec. 5, 2022

(30) Foreign Application Priority Data
Jul. 6, 2020 (JP) 2020-116165

(51) Int. Cl. G06F 16/632; G06F 40/40; G06F 16/638

(52) U.S. Cl. CPC G06F 16/632; G06F 40/40; G06F 16/638

(57) ABSTRACT

Information that matches personal hobbies, tastes, and trends is provided. An information search device comprises: an information acquisition unit that acquires sensor information; an information verbalization unit that verbalizes the sensor information acquired by the information acquisition unit; a general knowledge database storing language information and various information in association with each other; and a search unit that searches the general knowledge database on the basis of language information verbalized by the information verbalization unit, and outputs various information associated with the language information and with language information similar to such language information.

### TECHNICAL FIELD

The present invention relates to an information search device.

### BACKGROUND ART

There is PTL 1 as the background art of the technical field of the present invention. PTL 1 discloses that “there is provided an activity knowledge base storage unit that stores a combination of an activity of a person and an object, a place, a situation, a time, and the like that are targets of the activity as language information. Furthermore, a detection value related to the target of the above activity is first acquired from a sensor, and the acquired detection value is analyzed, is integrated with detection values obtained at the same time, and then is converted into language information that indicates the target. Furthermore, the language information indicating a corresponding activity is searched from the above activity knowledge base storage unit on the basis of the converted language information indicating the target, and language information of the highest appearance probability is selected from the searched language information, and is documented and output”.

This method makes it possible to recognize an activity without using teacher data or a manually created knowledge base, and consequently makes it possible to accurately recognize an activity without requiring a large amount of labor, time, and cost even in a case where a recognition target activity changes depending on a situation such as a time, a place, or the like (see Abstract).

There is PTL 2 as another background art. PTL 2 discloses that “biometric information of a user at the time of imaging capturing and subject information in a captured image are associated with captured image data, and stored. At a time of searching, a search condition is generated using biometric information and subject information to perform searching. Furthermore, the biometric information of a viewer at the time of searching is also used to generate the search condition. The subject information in the captured image is, for example, information related to an image of a person captured in the captured image. That is, an image which is appropriate for a user is selected and displayed under conditions of an emotion of a photographer, a facial expression of a person who is a subject, and the like, and further in consideration of an emotion of the user at the time of search, and the like”.

This method makes it possible to easily and appropriately search for captured images from a large amount of captured image data (see Abstract).

### CITATION LIST

### Patent Literature

PTL 1: JP 2016-126569 A
PTL 2: JP 2008-263274 A

### SUMMARY OF INVENTION

### Technical Problem

According to the invention disclosed in PTL 1, it is possible to verbalize from sensor information a combination of an object, a place, a situation, a time, and the like that are targets of an activity of a person, search an activity knowledge base with this language, and search for language information that indicates an activity corresponding to the target. However, it is not easy to assume information of a combination of an object, a place, a situation, a time, and the like that are sufficiently necessary to accurately indicate an arbitrary activity of a person before the activity is taken, and therefore it is not easy to install a sufficient number of types of sensors. Furthermore, an existing activity knowledge base is used, and therefore it is also difficult to provide information that reflects personal hobbies, tastes, and trends.

Furthermore, according to the invention disclosed in PTL 2, it is possible to acquire captured image data, biometric information at a time of image capturing of the user, and subject information that is an analysis result of the captured image data, associate and record these captured image data, biometric information and subject information in a recording medium, and thereby execute search processing by using the biometric information and the subject information. However, a format of a processing result varies depending on a type of information to be sensed, an algorithm to be processed, a sensor to be used, a person in charge, and the like, and therefore the biometric information and the subject information are inappropriate as search keywords.

It is therefore an object of the present invention to output information having high relevance with a person and an activity of the person on the basis of a result obtained by sensing the person and the activity of the person.

### Solution to Problem

To solve the above task, the information search device according to the present invention includes: an information acquisition unit that acquires sensor information; an information verbalization unit that verbalizes the sensor information acquired by the information acquisition unit; a general knowledge database that stores language information and various information in association; and a search unit that searches the general knowledge database on the basis of the language information verbalized by the information verbalization unit, and outputs the language information and the various information associated with language information similar to the language information.

Other means will be described in the description of the preferred embodiments.

### Advantageous Effects of Invention

According to the present invention, it is possible to output information having high relevance with a person and an activity of the person on the basis of a result obtained by sensing the person and the activity of the person.

### BRIEF DESCRIPTION OF DRAWINGS

FIG. 1 is a block diagram illustrating a network configuration where an information search device according to one embodiment of the present invention is centered.

FIG. 2 is a block diagram illustrating a configuration of the information search device.

FIG. 3 is a block diagram illustrating a configuration of a terminal device.

FIG. 4 is a functional block diagram of the information search device.

FIG. 5 is a block diagram illustrating a configuration of an information verbalization unit.

FIG. 6 is a functional block diagram of an information search device according to a second embodiment.

FIG. 7 is a functional block diagram of an information search device according to a third embodiment.

FIG. 8A is a flowchart (part 1) for explaining an operation of the information search device.

FIG. 8B is a flowchart (part 2) for explaining the operation of the information search device.

FIG. 9 illustrates a specific example of processing executed by the information search device according to the present embodiment.

FIG. 10 is a view illustrating an operation mode selection screen displayed on a display unit of the terminal device.

FIG. 11 is a view illustrating a model activity screen displayed on the display unit of the terminal device.

FIG. 12 is a view illustrating a “compare with past own activity” screen displayed on the display unit of the terminal device.

FIG. 13 is a view illustrating a recommendation screen displayed on the display unit of the terminal device.

### DESCRIPTION OF EMBODIMENTS

Hereinafter, although embodiments of the present invention will be described in detail with reference to the drawings, the present invention is not limited to the following embodiments, and various modifications and application examples are also included in a range of the technical concept of the present invention.

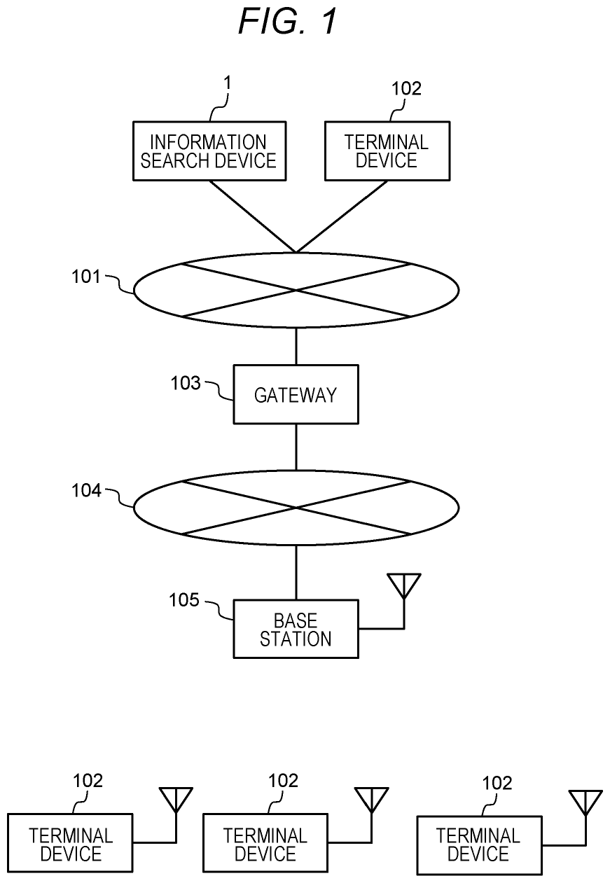

FIG. 1 is a block diagram illustrating a network configuration in which an information search device 1 according to the present embodiment is centered.

The information search device 1 is a server device that is connected to a network such as an Internet 101. A user can communicate with the information search device 1 via the Internet 101 by using a terminal device 102 owned by the user.

The terminal device 102 is, for example, various information terminal devices such as a smartphone, a tablet, and a personal computer. In a case where the terminal device 102 is a smartphone or the like, the terminal device 102 communicates with the information search device 1 via a base station 105 of a mobile communication network 104 connected with the Internet 101 via a gateway 103. Naturally, the terminal device 102 can also communicate with the information search device 1 on the Internet 101 without the mobile communication network 104. In a case where the terminal device 102 is a tablet or a personal computer, the terminal device 102 can communicate with the information search device 1 on the Internet 101 without the mobile communication network 104. Naturally, the terminal device 102 can also communicate with the information search device 1 via the mobile communication network 104 by using a wireless local area network (LAN) compatible device.

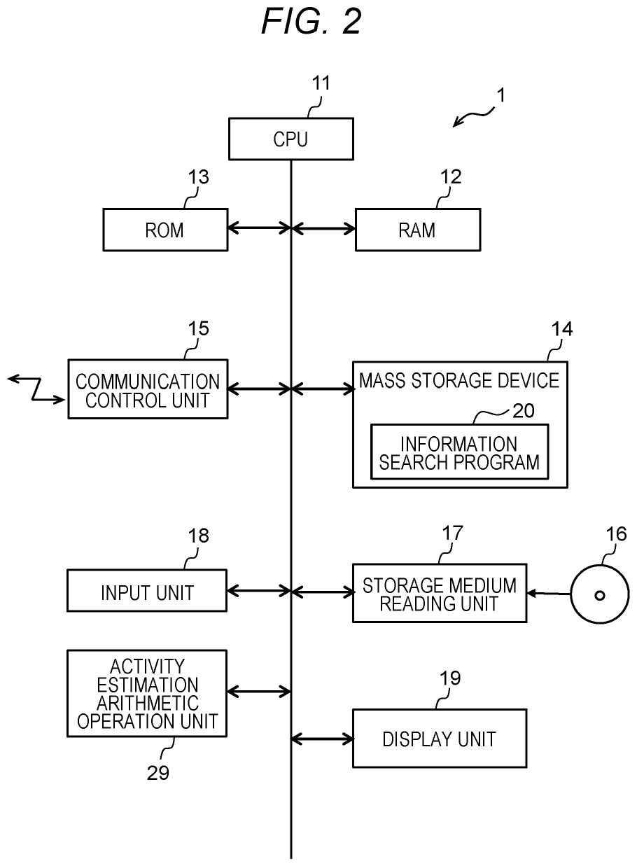

FIG. 2 is a block diagram illustrating a configuration of the information search device 1.

The information search device 1 includes a central processing unit (CPU) 11, a random access memory (RAM) 12, a read only memory (ROM) 13, and a mass storage unit 14. The information search device 1 includes a communication control unit 15, a recording medium reading unit 17, an input unit 18, a display unit 19, and an activity estimation arithmetic operation unit 29 each of which is connected with the CPU 11 via a bus.

The CPU 11 is a processor that performs various arithmetic operations and centrally controls each unit of the information search device 1.

The RAM 12 is a volatile memory, and functions as a working area of the CPU 11.

The ROM 13 is a non-volatile memory, and stores, for example, a basic input output system (BIOS).

The mass storage unit 14 is a non-volatile storage device that stores various items of data, and is, for example, a hard disk or the like. An information search program 20 is set up in the mass storage unit 14. The information search program 20 is downloaded from the Internet 101 or the like and set up in the mass storage unit 14. Note that a setup program of the information search program 20 may be stored in a recording medium 16 described later. At this time, the recording medium reading unit 17 reads the setup program of the information search program 20 from the recording medium 16 to set up in the mass storage unit 14.

The communication control unit 15 is, for example, a network interface card (NIC), and has a function of communicating with other devices via the Internet 101 or the like.

The recording medium reading unit 17 is, for example, an optical disk device, and has a function of reading data of the recording medium 16 such as a digital versatile disc (DVD) or a compact disc (CD).

The input unit 18 is, for example, a keyboard or a mouse, and has a function of inputting information such as a key code and position coordinates.

The display unit 19 is, for example, a liquid crystal display or an organic electro-luminescence (EL) display, and has a function of displaying characters, figures, or images.

The activity estimation arithmetic operation unit 29 is an arithmetic operation processing unit such as a graphic card or a tensor processing unit (TPU), and has a function of executing machine learning such as deep learning.

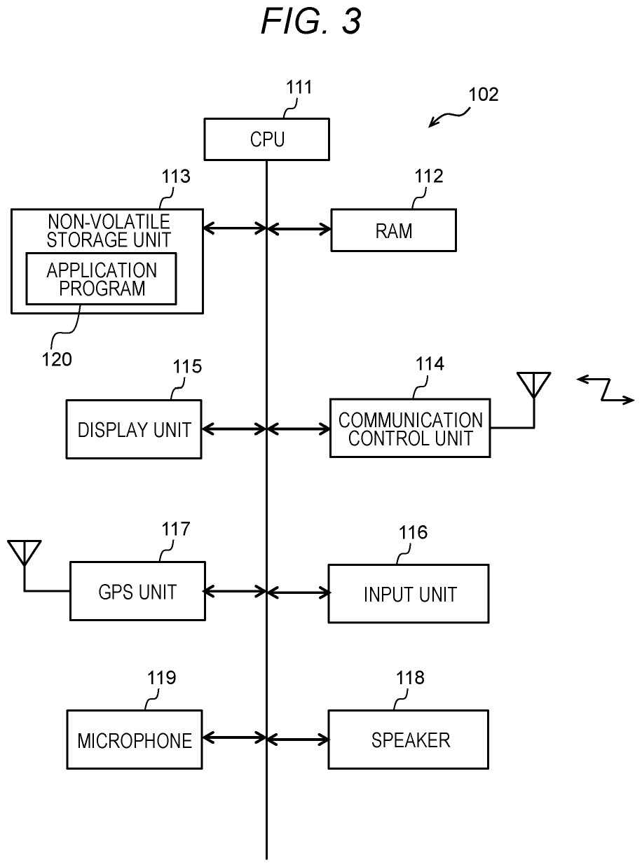

FIG. 3 is a block diagram illustrating a configuration of the terminal device 102. This terminal device 102 is an example of a smartphone.

The terminal device 102 includes a CPU 111, a RAM 112, and a non-volatile storage unit 113 that are connected with the CPU 111 via a bus. The terminal device 102 further includes a communication control unit 114, a display unit 115, an input unit 116, a global positioning system (GPS) unit 117, a speaker 118, and a microphone 119 that are also connected with the CPU 111 via the bus.

The CPU 111 has a function of performing various arithmetic operations and centrally controlling each unit of the terminal device 102.

The RAM 112 is a volatile memory, and functions as a working area of the CPU 111.

The non-volatile storage unit 113 includes a semiconductor storage device, a magnetic storage device, or the like, and stores various items of data and programs. A predetermined application program 120 is set up in this non-volatile storage unit 113. The CPU 111 executes the application program 120 to input information that needs to be searched for to the information search device 1, and display a result searched by the information search device 1.

The communication control unit 114 has a function of communicating with other devices via the mobile communication network 104 or the like. The CPU 111 communicates with the information search device 1 via the communication control unit 114.

The display unit 115 is, for example, a liquid crystal display or an organic EL display, and has a function of displaying characters, figures, images, or movies.

The input unit 116 is, for example, a button or a touch panel, and has a function of inputting information. The touch panel that constitutes the input unit 116 described herein may be laminated on a surface of the display unit 115. The user can input information to the input unit 116 by touching a touch panel provided on an upper layer of the display unit 115 with a finger.

The GPS unit 117 has a function of detecting a current position of the terminal device 102 on the basis of a radio wave received from a positioning satellite.

The speaker 118 converts an electric signal into an audio.

The microphone 119 records an audio and converts the audio into an electric signal.

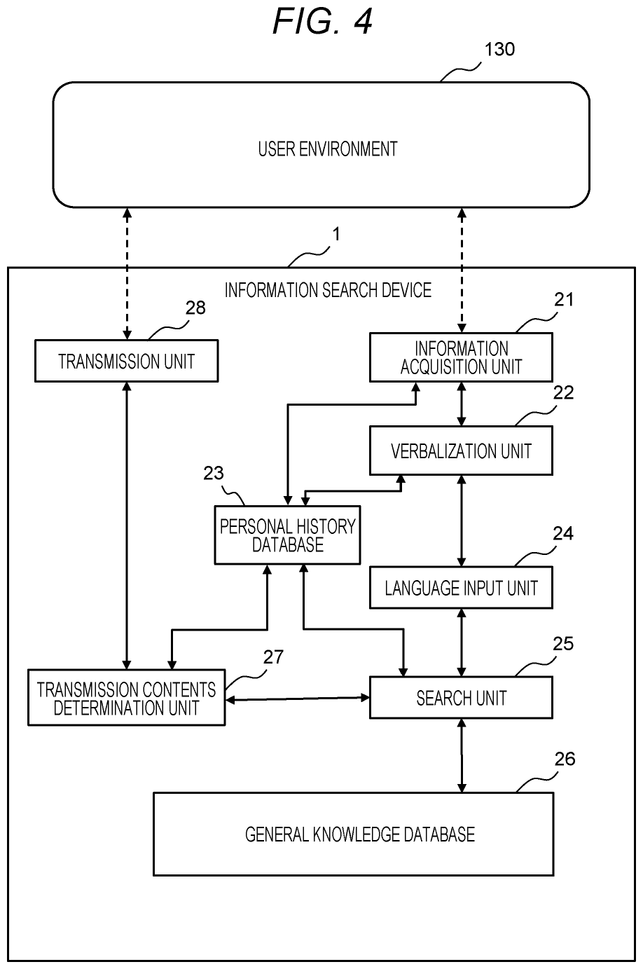

FIG. 4 is a functional block diagram of the information search device 1. This functional block diagram illustrates contents of processing executed by the information search device 1 on the basis of the information search program 20.

An information acquisition unit 21 acquires sensor information from a certain user environment 130. Furthermore, the information acquisition unit 21 acquires a request related to a service requested by a certain user, attribute information related to the user, and the like from the terminal device 102.

An information verbalization unit 22 verbalizes the sensor information acquired by the information acquisition unit 21. The information verbalization unit 22 further associates a word that is a result of verbalization and the sensor information related to the word to store in a personal history database 23. Consequently, the information search device 1 can present a result obtained by comparing a past activity and a current activity related to this user.

When the information acquisition unit 21 newly acquires sensor information from the user environment 130, the information verbalization unit 22 verbalizes this sensor information again. A search unit 25 searches a general knowledge database 26 by using the information such as words that is a result of verbalization, and outputs the information such as the words and various information associated with the information similar to the information.

The information acquisition unit 21 acquires sensor information of various formats from the user environment 130 by various means. Means for acquiring the sensor information from the user environment 130 is, for example, a sensing device including a camera, a microphone, or the like, or various sensors. The sensor information acquired from the user environment 130 is an electric signal obtained by converting biometric information such as brain waves, weather information or traffic information of people via the Internet 101 or the like, information related to diseases, economic information, environmental information, information from other knowledge databases, and the like. The format of the sensor information acquired from the user environment 130 is one of a text format such as comma-separated values (CSV) or JavaScript object notation (JSON), audio data, image data, a voltage, a digital signal, a coordinate value, a sensor instruction value, a feature, and the like.

The information verbalization unit 22 receives and verbalizes the sensor information output by the information acquisition unit 21.

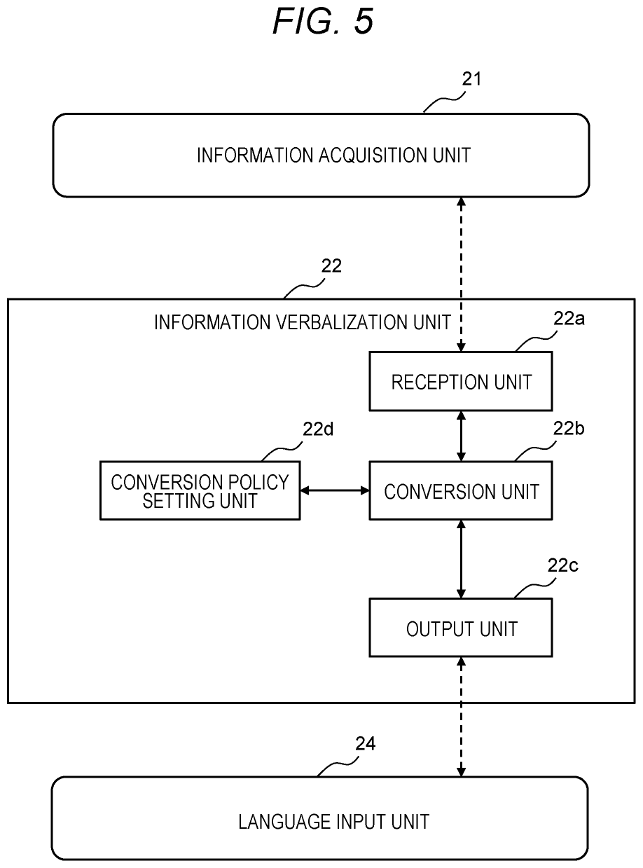

FIG. 5 is a block diagram illustrating a configuration of the information verbalization unit 22.

The information verbalization unit 22 is configured to include a reception unit 22a, a conversion unit 22b, an output unit 22c, and a conversion policy determination unit 22d.

The reception unit 22a receives the sensor information output from the information acquisition unit 21. In this regard, an operation scheme of the reception unit 22a may constantly maintain a reception state, or may confirm on the basis of another signal that the information acquisition unit 21 has transmitted information and transition to the reception state, or the reception unit 22a may make inquire of the information acquisition unit 21 whether or not there is the information. Furthermore, the reception unit 22a may have a function of enabling the user to register an output format of a new sensing device every time the new sensing device is used.

The conversion unit 22b converts the sensor information received by the reception unit 22a into information such as words. Hereinafter, the information such as the words converted by the conversion unit 22b may be referred to as “language information”. A policy for converting the sensor information into the information such as the words by the conversion unit 22b is stored in the conversion policy determination unit 22d. The conversion unit 22b operates according to this policy.

Options of a plurality of conversion policies are prepared in advance in the conversion policy determination unit 22d. The conversion policy includes converting, for example, an image or an emotion of a subject obtained by analyzing this image into words, converting a numerical value into information that a machine can understand, converting an audio into a code, and converting a smell or an aroma into a feature by deep learning or the like. The user can arbitrarily select one of a plurality of conversion policies.

Furthermore, types of a plurality of pieces of sensor information and a format of information such as a plurality of converted words may be prepared in advance as options in the conversion policy determination unit 22d. Consequently, the user can select the type of the sensor information and the format of the information such as the converted words stored in the conversion policy determination unit 22d in combination.

The output unit 22c outputs, to the language input unit 24, the information such as the words that is a result verbalized by the conversion unit 22b. The information such as the words output from the output unit 22c is encoded in some way. Consequently, the search unit 25 can search the general knowledge database 26 by using the information such as the words.

Back to FIG. 4, description continues. When receiving an input of the information such as the words that is an output result of the information verbalization unit 22, the language input unit 24 outputs this information such as the words to the search unit 25. The search unit 25 uses the information such as the words as search keywords.

The language input unit 24 may change a timing to input the information such as the words to the search unit 25 according to a search load. Furthermore, the language input unit 24 may acquire from the personal history database 23 attribute information such as a name, a sex, and an age of the user other than the language, information previously presented to this user by the information search device 1, and the like, and input the acquired information as one of the conditions for limiting the search range.

The personal history database 23 is a database that stores conditions, settings, personal information, information previously presented to the user by the information search device 1, and the like at a time when this user has previously used the information search device 1, and can be referred to when the same user uses the information search device 1 at a next or subsequent time. The personal history database 23 can provide information that matches personal hobbies and tastes.

The search unit 25 searches the general knowledge database 26 on the basis of the information such as the words input from the language input unit 24 and the information input from the personal history database 23, and outputs various information stored in association with the input information such as the words to the transmission contents determination unit 27.

The search unit 25 executes search by using similarity of the information such as the words as an index. When a condition for limiting the search range is input, the search range is limited on the basis of the condition. In this regard, the similarity of the words may be defined on the basis of that, for example, the similarity is high in a case of a synonym and the similarity is low in a case of an antonym, that is, on the basis of a meaning of the words. Alternatively, means that uses deep learning or the like indicated by a continuous bag-of-words (CBOW) in a bidirectional encoder representations from transformers (BERT) algorithm may generate word vectors matching a relationship with surrounding words in a sentence, and define similarity on the basis of a distance between these vectors. In this regard, the type of the distance between vectors is not limited as long as the distance is an index that can measure similarity such as a cosine distance, a Manhattan distance, a Euclidean distance, or a Mahalanobis' distance.

The transmission contents determination unit 27 receives various information associated with the information such as the words output from the search unit 25, refers to the personal history database 23, and selects information to be output to the transmission unit 28.

When, for example, the information acquisition unit 21 receives movie information showing that the user is practicing golf, this movie information is transmitted to the transmission contents determination unit 27 via the personal history database 23. The search unit 25 outputs a plurality of pieces of information associated with a word “golf”. The transmission contents determination unit 27 selects, for example, only information related to a form of golf on the basis of the movie information of golf practice to output to the transmission unit 28.

The transmission unit 28 provides the received information to the user. In this regard, means for providing the information to the user includes various means such as devices such as a personal computer, a smartphone, or a tablet, a method for stimulating five senses such as an auditory sense, an olfactory sense, and a gustatory sense, virtual reality (VR), augmented reality (AR), and the like. Furthermore, when these means are used, the result verbalized by the information verbalization unit 22 may be indicated together to facilitate understanding of the information presented to the user.

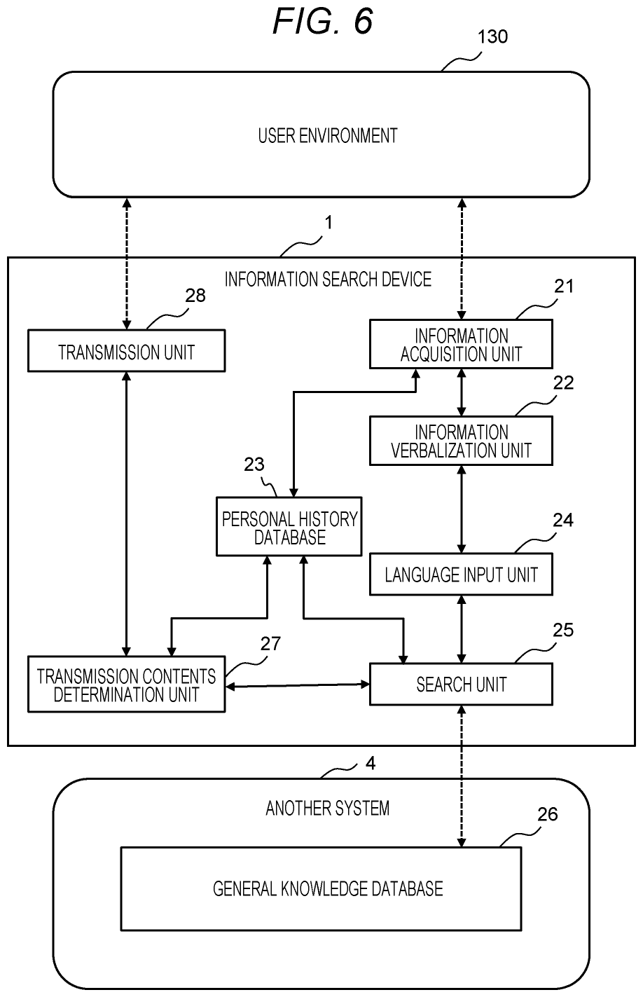

FIG. 6 is a functional block diagram of an information search device 1 according to a second embodiment.

Features of the second embodiment include that at least a part of a general knowledge database 26 exists in another system. In the second embodiment, the general knowledge database 26 may exist not only in another system of an own company but also in a system of another company, a cloud environment, or the like.

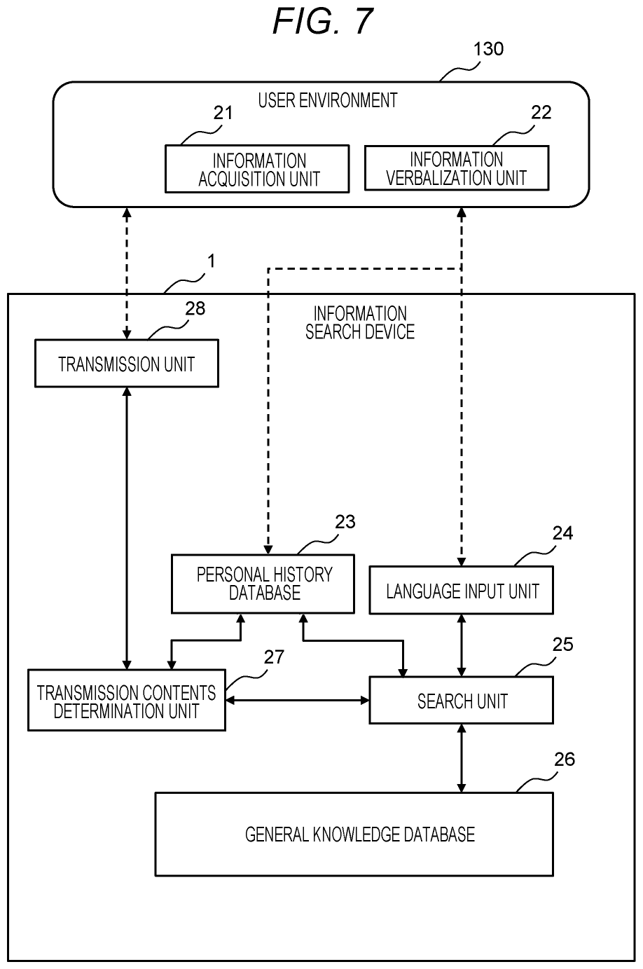

FIG. 7 is a functional block diagram of an information search device 1 according to a third embodiment.

Features of the information search device 1 according to the third embodiment include that an information acquisition unit 21 and an information verbalization unit 22 are included in a user environment 130. In the third embodiment, the information acquisition unit 21 and the information verbalization unit 22 may be executed by an edge terminal. Furthermore, information such as words verbalized in the edge terminal may be filtered when transmitted to the outside of the user environment 130, and transmission contents may be restricted according to a security level. Consequently, it is possible to protect user's privacy.

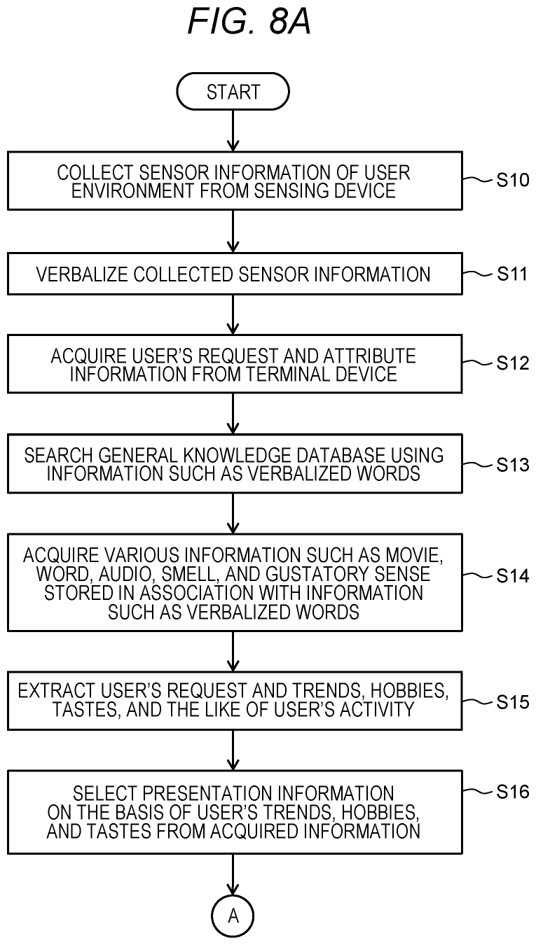

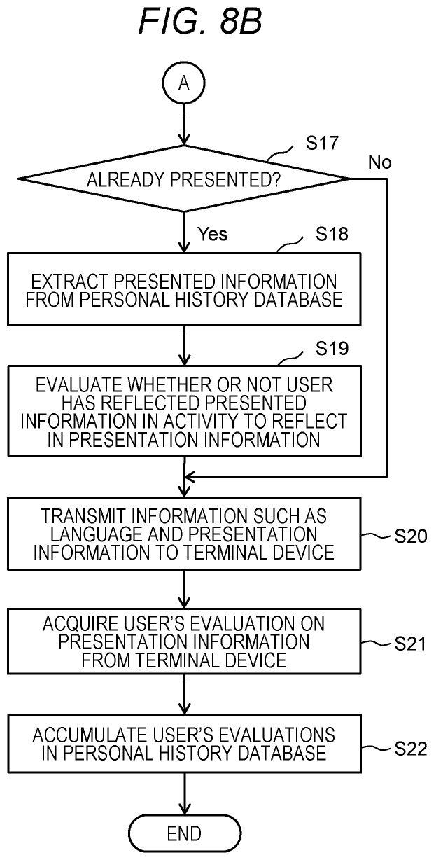

FIGS. 8A and 8B are flowcharts for explaining an operation of a system including the information search device 1.

The user is in the user environment 130 in which a sensing device or the like is installed, or in a state in which the sensing device is attached to a user's body. The user is further provided with a user interface for the information search device 1 by a display unit 115 of a terminal device 102 such as a computer, a tablet, or a smartphone, or means such as virtual reality or augmented reality.

The sensing device collects user information and environment information of the user. The sensing device is, for example, various sensors that detect a temperature, a humidity, an atmospheric pressure, an acceleration, an illuminance, a carbon dioxide concentration, presence of people, seating, a distance, a smell, a taste, a tactile sense, or the like, an audio device such as a microphone or a smart speaker, an image capturing device such as a camera, or the like.

The information acquisition unit 21 acquires sensor information related to the user environment 130 from the sensing device (S10).

The information verbalization unit 22 verbalizes the sensor information collected by the sensing device (S11). An example of a verbalization algorithm is a method for learning in advance teacher data including a combination of sensor information collected by the sensing device and words by machine learning or the like, and inputting the sensor information collected by the sensing device to a neural network that has finished the learning.

The information converted by the information verbalization unit 22 is not necessarily limited to words such as Japanese and English used by people for communication, and may be, for example, language information by tactile symbols typified by a braille or the like, code information that can be read and understood as is by a machine, visual symbol information typified by a sign or the like, color information, audio information, numerical value information, olfactory sense information, a feature extracted by an automatic encoder of deep learning, vector information, or the like. The information converted by the information verbalization unit 22 is not limited as long as the information has a specific meaning for a person, a machine, or an algorithm.

Furthermore, the user inputs a request related to a service requested by the user to the user interface of the terminal device 102. The information acquisition unit 21 acquires this request from the terminal device 102 (S12). In this regard, the request acquired by the information acquisition unit 21 is a request that is expected for an output of the information search device 1 such as presentation of a movie of a model motion, presentation of a difference from a past own activity, analysis of a current own activity, and the like.

Note that the information acquisition unit 21 may acquire various pieces of attribute information related to a person in question and environment such as information related to a surrounding environment such as a date, a time, a weather, a temperature, a fashion, congestion, transportation, and the like on a day, or a sex, a religion, companions, emotions such as comfort/discomfort, delight, anger, sorrow, and pleasure, health conditions such as breathing, pulse, brain waves, an injury, and diseases, and a target value of an activity on this day.

Furthermore, the information acquisition unit 21 accumulates in a personal history database 23 user's settings, activities, and the like that are based on the acquired request and attribute information. By analyzing this personal history database 23, it is possible to extract contents highly frequently set by the user, a trend of the user's activity, and the like.

Next, a search unit 25 searches a general knowledge database 26 by using information such as words converted by the information verbalization unit 22 (S13). The general knowledge database 26 stores various information such as movie information associated with the information such as the words, the words, audio information, smell information, gustatory sense information, and tactile sense information. Consequently, it is possible to provide information that appeals to five senses of a person.

Furthermore, this general knowledge database 26 stores information including expressions that express emotions. Consequently, it is possible to provide information that matches user's emotions.

The search unit 25 acquires from the general knowledge database 26 information associated with information such as searched words, and information associated with information having a meaning close to the information such as the searched word to output to a transmission contents determination unit 27 (S14).

The transmission contents determination unit 27 analyzes the personal history database 23, and extracts a request highly frequently made, and a trend, a hobby, a taste, and the like of a user's activity (S15).

Furthermore, the transmission contents determination unit 27 integrates various information obtained by searching the general knowledge database 26, the request highly frequently made by the user, the trend, the hobby, the taste, and the like of the user's activity, and selects information to be presented to the user (S16). There may be provided various criteria as criteria for transmission contents determination unit 27 to select the presentation information such as presentation information highly evaluated by the user previously, presentation information that is slightly different from information highly frequently requested by the user and gives a new viewpoint, presentation information that predicts a user's future activity, presentation information that the user does not touch in recent several times, and presentation information that is desirable for health management of a person.

Furthermore, the transmission contents determination unit 27 decides whether or not the information has already been presented in response to this user's request (S17). In a case where the information has already been presented in response to this user's request (Yes), the transmission contents determination unit 27 extracts the information presented in response to this user's request from the personal history database 23 to compare with the current user's activity (S18), and evaluates how the user has reflected the presented information in the activity to reflect this evaluation result in the current presentation information (S19). In a case where the information has not yet been presented in response to this user's request (No), the transmission contents determination unit 27 proceeds to processing in step S20.

For example, a case is considered where the information search device 1 presents information indicating that “You may raise your arm a little more” to a certain user, and this user raises the arm by 5 cm during the current activity. The transmission contents determination unit 27 of the information search device 1 accumulates in the personal history database 23 that the word “a little” for this user means approximately 5 cm.

In this regard, it is appropriate to use expressions such as “a little more” in a case where it is necessary to make the user raise the arm by 3 cm more, and “greatly” in a case where it is necessary to make the user raise the arm by 10 cm more. A distance indicated by this word “a little” varies depending on users. Therefore, the information search device 1 may accumulate a relationship between words and objective numerical values per user in the personal history database 23. Furthermore, in a case where a certain user does not reflect the information previously presented to this user, the information search device 1 may also present this information together.

In step S20, a transmission unit 28 transmits the finally selected presentation information to the terminal device 102. The terminal device 102 displays the presentation information via the display unit 115. At this time, by simultaneously presenting the information such as the words converted by the information verbalization unit 22, too, the user can more deeply understand the presentation information.

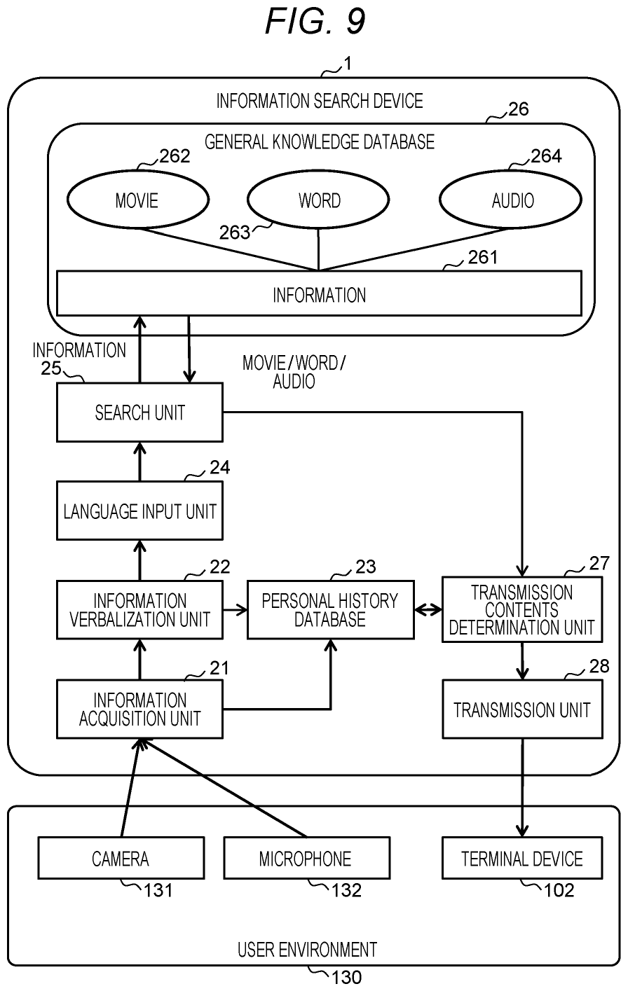

The user can feed back the evaluation of the presentation information via an input unit 116. The evaluation input via the input unit 116 is transmitted to the information search device 1 by a communication control unit 114. When the information acquisition unit 21 acquires the user's evaluation on the presentation information from the terminal device 102 (S21), and accumulates the user's evaluation in the personal history database 23 (S22), the processing in FIG. 9 is finished. According to the user's evaluations accumulated in the personal history database 23, the information search device 1 can select and provide information highly evaluated by the user. In a case where, for example, the information of an angle of an arm is provided for rehabilitation, but the user's evaluation is low, it is preferable to provide information from other viewpoints such as information of walking during the rehabilitation.

Next, a specific example of processing executed by the information search device 1 according to the present embodiment will be described.

FIG. 9 illustrates a specific example of the processing executed by the information search device 1 according to the present embodiment. First, as preliminary preparation, the user moves to the user environment 130 in which a sensor and a sensing device including a camera, a microphone, and the like are installed, or attaches the sensor to a body. This sensor is, for example, a small sensor having a function of a pedometer, a pulsometer, a thermometer, an accelerometer or the like, and may have a function of wirelessly transmitting data.

Next, the user inputs a desired operation mode to the information search device 1 by a terminal device 102 such as a computer, a tablet, or a smartphone, or by means of virtual reality, augmented reality, or the like.

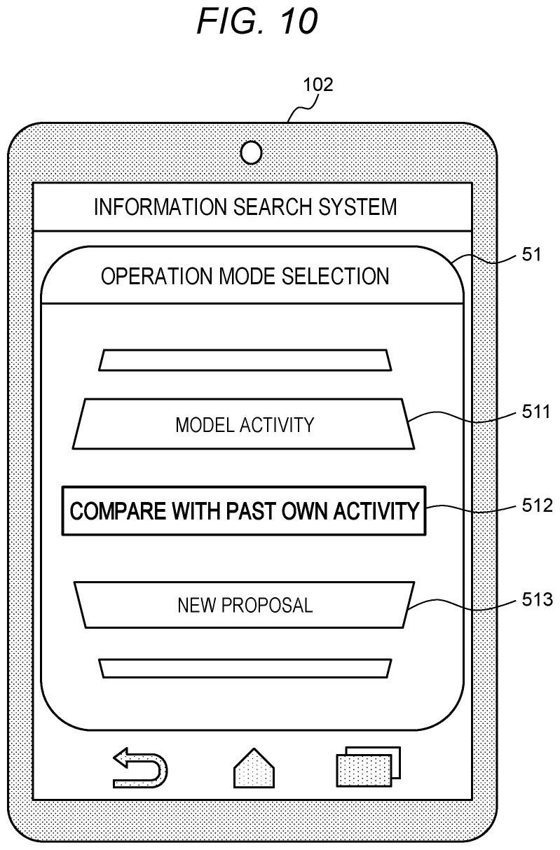

FIG. 10 is a view illustrating an operation mode selection screen 51 displayed on the display unit 115 of the terminal device 102.

This operation mode selection screen 51 displays a “model activity” 511, “compare with past own activity” 512, and a “new proposal” 513 on a spin control. This operation mode selection screen 51 functions as a user interface for inputting a user's request and attribute information.

The “model activity” 511 is presentation of a model motion by a professional, a person at the same level as that of the professional, or the like. The “compare with past own activity” 512 is display of a difference from a past own motion. The “new proposal” 513 is a new proposal from a new viewpoint.

### Specific Example 1

Hereinafter, the operation of an entire system including the information search device 1 will be specifically described assuming that the user performs a golf motion. The following description will be made with reference to FIG. 9 as appropriate.

The user who has finished the above-described preliminary preparation selects, for example, the “model activity” 511 on the operation mode selection screen 51. Next, when a golf motion is actually performed, sensor information such as a swing speed, a speed of the shot ball, a swing posture, a facial expression, a ball-hitting sound, a used tool, a temperature and a humidity of a surrounding environment, a time, breathing, and a heart rate acquired by a sensor 122 and a sensing device 123 is transmitted to the information acquisition unit 21 of the information search device 1.

The information verbalization unit 22 verbalizes the current activity into the word “golf” from this sensor information. Next, the search unit 25 searches the general knowledge database 26 using this word “golf”, and extracts various information such as movie information of a professional associated with the word “golf”, a ball-hitting sound, an image picture, a rule, a role played in a personal relationship, an effect on health maintenance, a player population, a history, and cost. The general knowledge database 26 is configured to include information 261 including words, and various information such as a movie 262, a word 263, and an audio 264 associated with the information 261.

The transmission contents determination unit 27 combines the information extracted by the search unit 25 and the user's request for the model activity, and determines the movie information of the professional as the model activity. The transmission contents determination unit 27 compares the user's activity with a professional's activity, and generates an advice for improving the user's activity closer to the model activity. Furthermore, the transmission contents determination unit 27 also accumulates this presentation information in the personal history database 23. The transmission unit 28 transmits this presentation information to the terminal device 102.

The terminal device 102 displays this presentation information on the display unit 115.

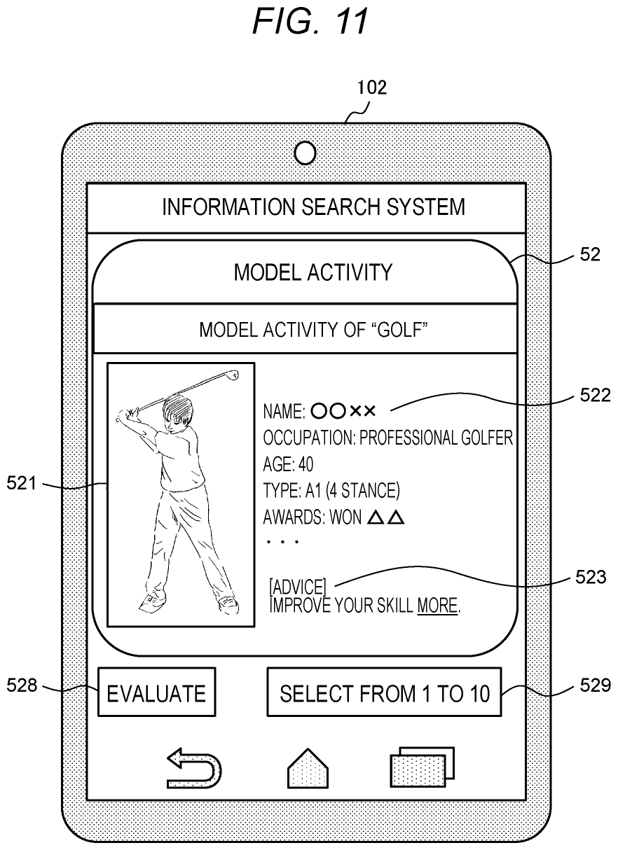

FIG. 11 is a diagram illustrating the model activity screen 52 displayed on the display unit 115 of the terminal device 102.

The display unit 115 of the terminal device 102 displays the model activity screen 52. This model activity screen 52 simultaneously displays “golf” that is the word converted by the information verbalization unit 22, a model movie 521 related to golf, and information 522 related to the model movie 521 such as a name, an occupation, and an age of a subject.

The model activity screen 52 further displays an advice 523 for improving the user's activity closer to the model activity. This advice 523 is generated by comparing the user's activity with the model movie. The advice 523 is further optimized for each individual by calculating from the data of the personal history database 23 how much the user's activity has changed in response to information previously presented to the same user.

An evaluation button 528 is used to input a user's evaluation on presented contents. When the evaluation button 528 is tapped, another screen is opened, and evaluation sentences can be freely described therein. A “select from 1 to 10” button 529 is used to input the user's evaluation on the presented contents at 10 levels from 1 to 10.

In a case where, for example, the information search device 1 has previously presented information with words “Shake your arm a little more”, and the user has shaken the arm 5 cm more, the information search device 1 may select the word “more” this time to express that the user shakes the arm 10 cm more. A distance indicated by the words “a little more” varies depending on the user, and therefore a relationship between the words and an objective numerical value may be accumulated per user in the personal history database 23.

### Specific Example 2

Hereinafter, the operation of the system including the information search device 1 will be specifically described assuming that a user is a person undergoing rehabilitation at a field of nursing care. The following description will be made with reference to FIG. 9 as appropriate.

Similar to Specific Example 1, the user who has finished the preliminary preparation selects, for example, the “compare with past own activity” 512 on the operation mode selection screen 51 illustrated in FIG. 10.

Next, when the user makes a motion of raising an arm upward for rehabilitation, the sensor 122 and the sensing device 123 acquire sensor information of this activity. The information verbalization unit 22 converts the acquired sensor information into words “(personal name)” and “rehabilitation”.

Next, the search unit 25 searches the general knowledge database 26 using these words, and searches for various information associated with the words “(personal name)” and “rehabilitation”.

The transmission contents determination unit 27 decides that it is appropriate to present past activity data of the user to the user this time in response to a user's request for “compare with past own activity”. The transmission contents determination unit 27 extracts activity information (such as movie information) related to past rehabilitation from the personal history database 23 on the basis of the words “(personal name)” and “rehabilitation”, compares this activity information and the current movie information, and determines presentation information. Note that the transmission contents determination unit 27 may search for information related to rehabilitation from the personal history database 23, and extract information such as a rehabilitation start date, past activity information (sensor information), past user evaluations, meeting dates with relatives, a personality, a nationality, a religion, an age, a height, a weight, and the like.

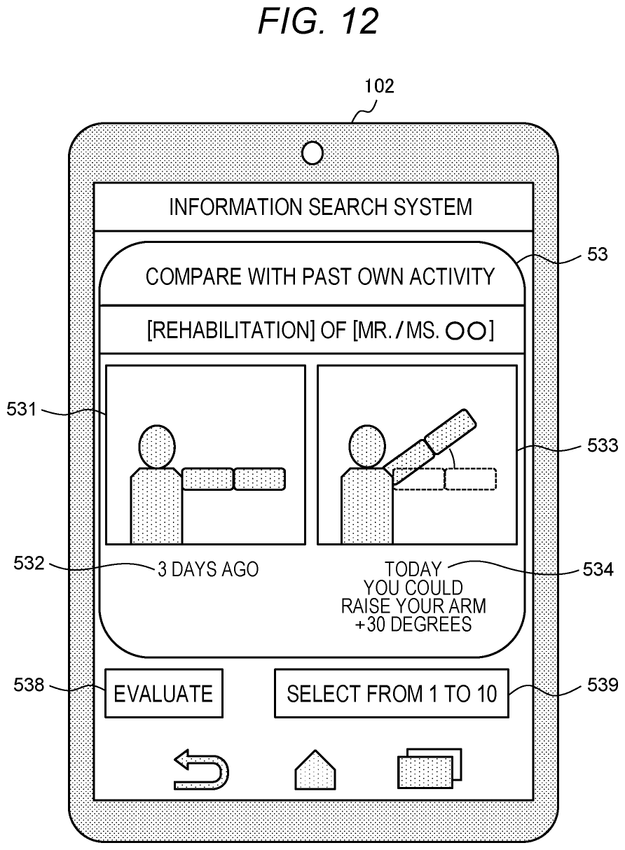

Furthermore, the transmission contents determination unit 27 accumulates this presentation information in the personal history database 23, too. This presentation information is displayed in, for example, a format illustrated in FIG. 12 on the display unit 115 of the terminal device 102 by the transmission unit 28.

FIG. 12 is a view illustrating a “compare with past own activity” screen 53 displayed on the display unit 115 of the terminal device 102.

The “compare with past own activity” screen 53 displays the words “(personal name)” and “rehabilitation” that are results verbalized by the information verbalization unit 22, a “past self” image 531 that is presentation information, a date 532 thereof, a “current self” image 533, and a date 534 thereof, and further displays a word “You could raise your arm by +30 degrees”.

The “current self” image 533 shows a position of the arm in the “past self” image 531 as a broken line, and further shows an angle difference in the arm position. As described above, a result of comparison with the past own activity is specifically indicated by a number or a change in the image.

An evaluation button 538 is used to input a user's evaluation on presented contents. When the evaluation button 538 is tapped, another screen is opened, and evaluation sentences can be freely described therein. A “select from 1 to 10” button 539 is used to input the user's evaluation on the presented contents at 10 levels from 1 to 10.

### Specific Example 3

Hereinafter, an operation of the system including the information search device 1 will be specifically described assuming a situation that new product coffee matching a user's preference is proposed. The following description will be made with reference to FIG. 9 as appropriate.

Similar to Specific Example 1, the user who has finished the preliminary preparation selects, for example, the “new proposal” 513 on the operation mode selection screen 51 illustrated in FIG. 10.

Next, when the user drinks coffee, the sensor 122 and the sensing device 123 acquire sensor information. The information verbalization unit 22 converts this sensor information into words “(personal name)” and “coffee”. Next, the search unit 25 searches the general knowledge database 26 using the converted words, and extracts various information such as an intake interval, an intake amount, a taste preference, an aroma preference, a side dish preference, a background music (BGM) preference, and an intake place preference associated with the words “(personal name)” and “coffee”.

The transmission contents determination unit 27 combines the various information extracted by the search unit 25 and the user's request for the new proposal, and decides that it is appropriate to present, to the user, coffee whose taste, aroma, and side dish match the user's preference among new product coffees this time. For example, a method for selecting this new product to be presented stores a conversion vector that indicates a relationship between the word “coffee” and a favorite coffee taste and aroma per user, and selects a product that has a conversion vector close to the conversion vector that indicates this user's preference among the new product coffees.

Furthermore, the transmission contents determination unit 27 can select a new product that matches the user's preference, yet partially includes a new element by minutely perturbing a conversion vector indicating the user's preference using a normal distribution or the like. Furthermore, the transmission contents determination unit 27 may propose coffee that includes an element that is expected to be rarely experienced by the user usually while leaving an element matching the user's preference by intentionally inverting at least one component of the conversion vector indicating the user's preference.

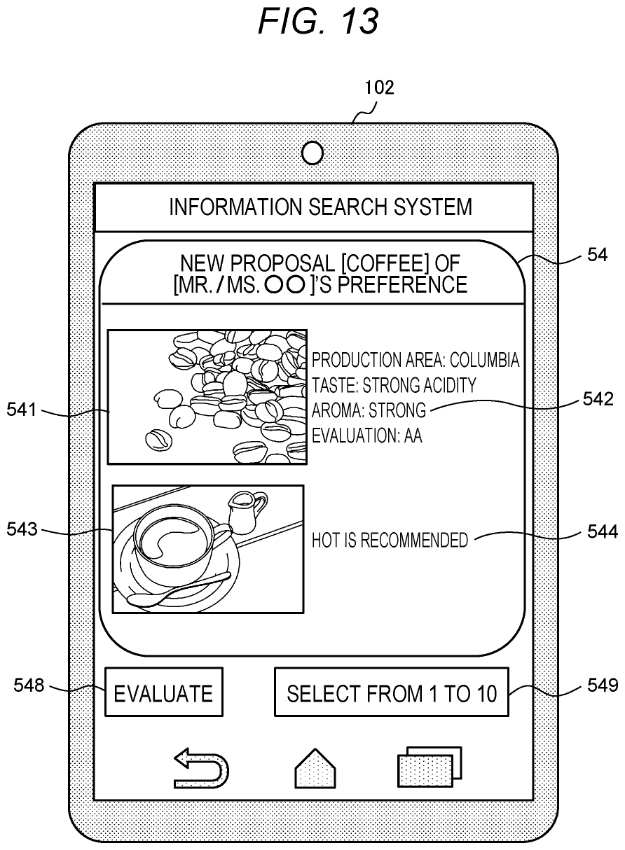

Furthermore, this presentation information is also accumulated in the personal history database 23. This presentation information is displayed in, for example, a format illustrated in FIG. 13 on a recommendation screen 54 by the transmission unit 28.

FIG. 13 is a diagram illustrating the recommendation screen 54 displayed on the display unit 115 of the terminal device 102.

The display unit 115 displays the recommendation screen 54, and displays proposal information together with the words “(personal name)” and “coffee” that are results verbalized by the information verbalization unit 22. An Image 541 is an image of recommended coffee beans. Information 542 indicates a production area, a taste, an aroma, and other users' evaluations of the coffee beans. The image 543 is an image of coffee brewed in a cup. The information 544 specifically describes a recommended way of drinking.

Furthermore, the user can evaluate this presented contents similar to Specific Example 1.

An evaluation button 548 is used to input a user's evaluation on presented contents. When the evaluation button 548 is tapped, another screen is opened, and evaluation sentences can be freely described therein. A “select from 1 to 10” button 549 is used to input the user's evaluation on the presented contents at 10 levels from 1 to 10.

(Modification)

The present invention is not limited to the above embodiments, and includes various modifications. For example, the above embodiments have been described in detail to describe the present invention for ease of understanding, and is not necessarily limited to those including all described components. Part of components of a certain embodiment can be replaced with components of the other embodiments, and the components of the other embodiment can be also added to the components of the certain embodiment.

Furthermore, as part of the components of each embodiment, the other components can be also added, deleted, or replaced.

Part or all of each of the above components, functions, processing units, and processing means may be realized as hardware such as an integrated circuit. Each of the above components and functions may be realized as software when a processor interprets and executes a program that realizes each function. Information such as a program, a table, and a file that realizes each function can be stored in recording devices such as memories, hard disks, and solid state drives (SSDs) or recoding media such as flash memory cards and digital versatile disks (DVDs).

Each embodiment has described control lines and information lines as components that are considered to be necessary for description, and do not necessarily indicate all control lines and information lines in terms of products. Practically, it may be considered that almost all the components are connected with each other.

### REFERENCE SIGNS LIST

1 information search device
11 CPU
12 RAM
13 ROM
14 mass storage unit
15 communication control unit
16 recording medium
17 recording medium reading unit
18 input unit
19 display unit
20 information search program
21 information acquisition unit
22 information verbalization unit
22a reception unit
22b conversion unit
22c output unit
22d conversion policy determination unit
23 personal history database
24 language input unit
25 search unit
26 general knowledge database
27 transmission contents determination unit
28 transmission unit
29 activity estimation arithmetic operation unit
101 internet
102 terminal device
103 gateway
104 mobile communication network
105 base station
111 CPU
112 RAM
113 non-volatile storage unit
114 communication control unit
115 display unit
116 input unit
117 GPS unit
118 speaker
119 microphone
120 application program
121 wireless communication
130 user environment
51 operation mode selection screen
511 “model activity”
512 “compare with past own activity”
513 “new proposal”
52 model activity screen
521 model movie
522 information
523 advice
528 evaluation button
529 “select from 1 to 10” button
53 “compare with past own activity” screen
531 “past self” image
532 date
533 “current self” image
534 date
538 evaluation button
539 “select from 1 to 10” button
54 recommendation screen
541 image
542 information
543 image
544 information
548 evaluation button
549 “select from 1 to 10” button

1. An information search device comprising:
an information acquisition unit that acquires sensor information;
an information verbalization unit that verbalizes the sensor information acquired by the information acquisition unit;
a general knowledge database that stores language information and various information in association; and
a search unit that searches the general knowledge database on the basis of the language information verbalized by the information verbalization unit, and outputs the language information and the various information associated with language information similar to the language information.

2. The information search device according to claim 1, further comprising a personal history database that records user's evaluation on a search result.

3. The information search device according to claim 2, further comprising a transmission contents determination unit that determines transmission contents for the user by referring to information extracted by the search unit and information extracted from the personal history database.

4. The information search device according to claim 3, wherein the personal history database stores the language information output from the information verbalization unit.

5. The information search device according to claim 1, wherein an output of the information verbalization unit is encoded.

6. An information search device comprising:
an information acquisition unit that acquires sensor information and language information obtained by verbalizing the sensor information from an edge device;
a general knowledge database that stores language information and various information in association; and
a search unit that searches the general knowledge database on the basis of the language information acquired by the information acquisition unit, and outputs the language information and the various information associated with language information similar to the language information.

7. The information search device according to claim 6, wherein the language information obtained by verbalizing the sensor information is filtered.

8. An information search device comprising:
an information acquisition unit that acquires sensor information and language information obtained by verbalizing the sensor information; and
a search unit that searches a general knowledge database that stores language information and various information in association, on the basis of the language information, and outputs the language information and the various information associated with language information similar to the language information.

9. The information search device according to claim 8, wherein the various information associated with language information and stored in the general knowledge database includes an expression that expresses an emotion.

10. The information search device according to claim 8, wherein the various information associated with the language information and stored in the general knowledge database includes one or more of movie information, audio information, smell information, gustatory sense information, and tactile sense information.
